(19) United States
(12) Patent Application Publication
(10) Pub. No.: US 2004/0143557 A1
(43) Pub. Date: Jul. 22, 2004

(54) Method for fronking postal deliveries and a graphical user interface for carrying out said method

(76) Inventors: Jurgen Lang, Bergisch Gladbach (DE); Bernd Meyer, Konigswinter (DE)

Correspondence Address: Marshall Gerstein & Borun, 6300 Sears Tower, 233 South Wacker Drive, Chicago, IL, 60606-6357, US

(21) Appl. No.: 10/471,965

(22) PCT Filed: Mar. 19, 2002
(86) PCT No.: PCT/DE02/00996

(30) Foreign Application Priority Data
Mar. 21, 2001 (DE) 101 13 913.6

(51) Int. Cl. G06F 17/60

(52) U.S. Cl. 705/401

(57) ABSTRACT

The invention relates to a method for franking postal deliveries, whereby the franking process is controlled by a graphical user interface. According to the invention, the method is carried out in such a way that a screen menu appears during the selection of graphical representation of a franking design. The menu contains command buttons for selecting a franking option. The invention also relates to a graphical user interface suitable for carrying out the method.

### BACKGROUND ON THE INVENTION

1. Field of the Invention

2. Description of Related Technology

European Patent Application Publication No. 0 876 840 discloses a graphical user interface for an automatic franking machine. This prior art user interface allows a flexible selection of franking functions. The graphical representation also comprises includes a plain depiction of an envisaged franking imprint as well as touch-sensitive areas that are arranged outside of the image of the franking imprint and that serve to select franking functions.

The invention relates to a method for franking postal deliveries, whereby the franking is controlled by a graphical user interface.

The invention also relates to a user interface that is suitable for carrying out said method.

European Patent Application No. 0 876 840 discloses a graphical user interface for an automatic franking machine. This prior art user interface allows a flexible selection of franking functions. The graphical representation also comprises a plain depiction of an envisaged franking imprint as well as touch-sensitive areas that are arranged outside of the image of the franking imprint and that serve to select franking functions.

The invention is based on the objective of further refining a method of this generic type such that it can be carried out even more flexibly.

According to the invention, this objective is achieved in that, when a graphical representation of a design of the postage indicium is selected, a screen menu opens that contains a command panel for selecting franking options.

Another subject matter of the invention is to further refine a user interface for a franking system with a plain representation of a design of an imprint of a postage indicium to be generated such that it likewise allows the most flexible possible creation of postage indicia.

This objective is achieved according to the invention in that, at least in certain areas, the graphical representation is configured as a command panel for selecting the franking options.

This graphical user interface allows an especially simple and advantageous execution of the method presented.

The graphical user interface stands out for its particular user-friendliness.

In order to enhance the user-friendliness of the user interface, it is advantageous that, when the command panel is selected, a drop-down menu appears which has calculation and/or selection options for postage amounts.

In order to further increase the user-friendliness, it is advantageous for the drop-down menu to contain preset franking amounts.

Preferably, this is achieved in that the drop-down menu contains command panels for selecting postage amounts.

In order to avoid the generation of postage indicia with invalid franking options, it is advantageous for the drop-down menu to contain a list with possible delivery modalities for the mailpieces that are to be franked.

Here, it is advantageous to enhance the user-friendliness in that the selectable postal classes are displayed in a window.

Moreover, for purposes of further enhancing the user-friendliness, it is advantageous that, when a postal class is selected, optional additional services are displayed in another window.

An especially preferred embodiment of the invention stands out for the fact that the graphical representation of the design of the imprint of the postage indicium to be generated which, at least in certain areas, is configured as a command panel for selecting the franking options, is embedded in a screen display of a text document.

This embodiment of the invention allows an especially simple and user-friendly integration of the method for generating postage indicia in an application program.

For example, it is thus possible for the user of a PC to create a text, for instance, by manually writing or by loading mail-merge options. In order to frank mailpieces for postal delivery, especially letters or address labels, the franking function can be selected and process steps can be initiated in order to generate an imprint of a postage indicium—if desired, at first only reproduced as an example.

In addition to the especially preferred implementation of the address fields of text documents in the form of command panels for generating postage indicia, it is likewise advantageous to create the designs of addresses generated in another manner, for example, by a database, with command panels for the postage indicia.

Additional advantages, special features and practical refinements of the invention ensue from the subclaims and from the following representation of preferred embodiments with reference to the drawings.

The drawings show the following:

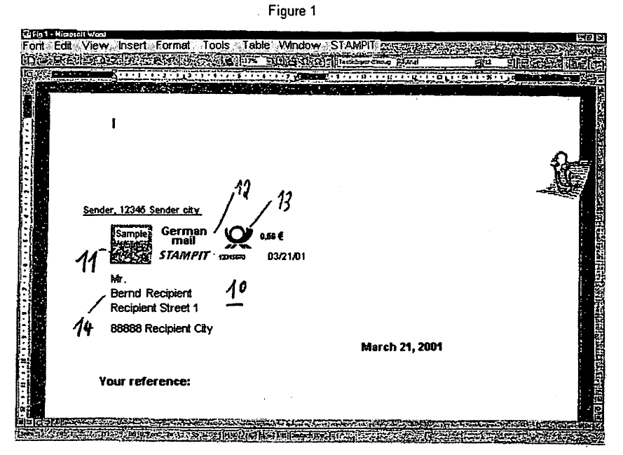

FIG. 1 a display representation of a word processing program with an open text document in whose address field a franking object has been inserted;

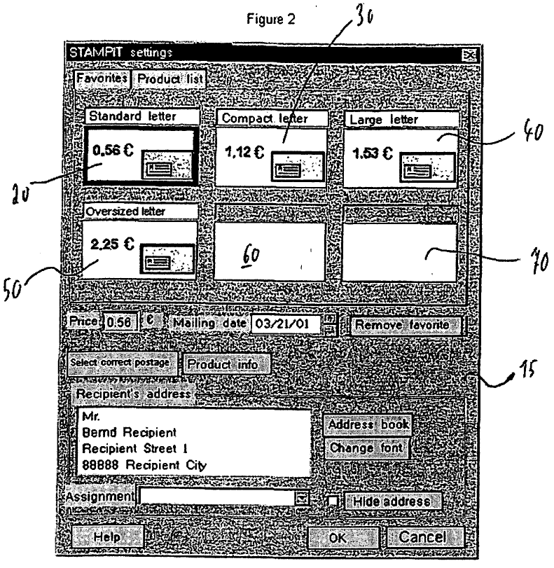

FIG. 2 a drop-down menu with preset franking values and

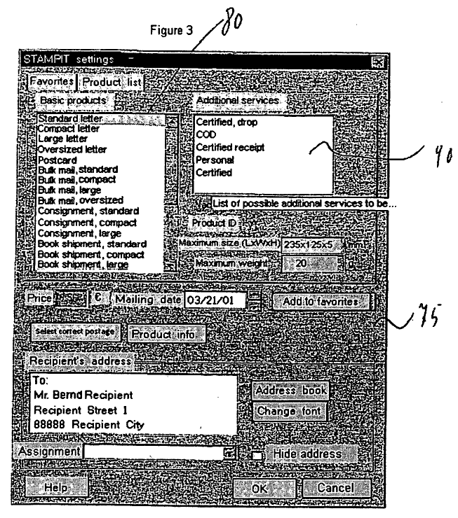

FIG. 3 a screen window with selectable postal classes.

The following representation shows an especially preferred use of the invention when integrated into a word processing program.

The screen surface of the word processing program in FIG. 1 shows a letter opened by the word processing program, whereby a postage indicium can be seen in the address field of the letter.

The postage indicium shown, which is also designated as postage indicium 10 without any limitations in the meaning, contains several components.

One component of the postage indicium 10 is a two-dimensional bit pattern 11, whereby the bit pattern 11 contains information that makes it possible to check whether the postage indicium 10 is genuine.

In order to allow an integration of the postage indicium 10 into the document without the risk that the user will be charged for a postage amount in a document that has not yet been printed out, it is advantageous for a program that serves to generate the postage indicium to include a test mode.

In the test mode, the design of an imprint of the postage indicium 10 to be generated is characterized in that it shows the user as well as any third party, especially a payment assurance center or an automatic checking unit, that this is a postage indicium that has not yet been finalized, but rather that this is just a design that serves as a placeholder.

Moreover, the design of the postage indicium contains an indication 12 of the producer of a customer system, which controls the generation of the postage indicium, the serial number 12345678 of the generating customer system in plain text, a symbol 13 of the postal service provider that acknowledges the postage indicium as valid and a recipient address 14.

It is especially advantageous for the postage indicium 10 to contain all of the mentioned components, but a selection of individual components is likewise possible. Nevertheless, the highest possible level of manipulation security and user-friendliness is ensured by integrating as many of these components into the postage indicium as possible.

The graphical representation of the postage indicium 10 can be inserted automatically into a desired place, especially into the address field, for example, with a special program routine as well as manually, for instance, by using dragging or copying routines of the operating system or with an application program.

In the case at hand here, the entire postage indicium 10 is configured as a command panel. If the pointer of a cursor device, especially a computer mouse or trackball, is in the area of the command panel 10, then the selection of a special function, particularly by means of the familiar so-called “double click”, can start a special program routine.

The program routine starts by opening a first screen menu 15, for example, a window in which postal classes, including the appertaining postage amounts, are shown as command panels 20, 30, 40, 50, 60, 70.

Here, it is possible to predefine the postal classes depicted as command panels 20, 30, 40, 50, 60, 70 or to allow the user to design these command panels. Such a window 15 is shown in FIG. 2 by way of an example.

FIG. 3 shows another screen menu 75 as a window containing the most complete possible product list of mailpieces that are to be franked. A first partial window 80 shows basic products such as, for example, a standard letter, a compact letter, a large letter, an oversized letter or a postcard. Once one of these basic products has been selected as the postal class, then the available additional services appear in another partial window 90.

The appropriate postage amount is calculated automatically.

For example, when a standard letter is selected, first of all, a price of 0.56 euros is displayed, as well as the available additional services such as drop-off registered letter, C.O.D. and registered letter with return receipt.

Once one or more of these additional services have been selected, then the additional services that constitute available additional services to supplement the first additional service are automatically displayed.

Thus, for example, if the additional service “registered” is selected, then additional services such as “return receipt” and “personal delivery” are displayed.

When one or more of these additional services are selected, the amount to be paid for generating the final postage indicium is correspondingly increased.

For example, in the case shown here, the postage amount increases when the additional service “registered” and the further additional service “return receipt” are selected.

By loading another program routine, a final postage indicium is generated.

A print-out of the text document is possible in the test mode as well as with the correct postage indicium inserted.

However—unlike the generation of a final postage indicium—the user is not charged for the print-out of a text document with an invalid postage indicium that is specifically designated as “sample”.

The final generated postage indicia can be invoiced in various ways; for example, by reducing a postage account stored in a customer system or by invoicing via a separate list.

The invention, however, is not limited to any one of the invoicing modalities described.

The other components of the representation should also only be understood as examples.

1. A method for franking postal deliveries, whereby the franking (10) is controlled by a graphical user interface, characterized in that, when a graphical representation of a design of the postage indicium is selected, a screen menu (15, 17) opens that contains a command panel (20, 30, 40, 50, 60 70; 80, 90) for selecting franking options.

2. A user interface for a franking system with a graphical representation of a design of an imprint of a postage indicium (10) to be generated, characterized in that, at least in certain areas, the graphical representation is configured as a command panel for opening a screen menu (15, 75).

3. The user interface according to claim 2, characterized in that, when the screen menu (15, 75) is selected, a drop-down menu appears which has calculation and/or selection options for postage amounts.

4. The user interface according to claim 3, characterized in that the drop-down menu contains preset franking values.

5. The user interface according to claim 4, characterized in that, in the drop-down menu, there are command panels (20, 30, 40, 50, 60, 70) for selecting postage amounts.

6. The user interface according to one or more of claims 4 or 5, characterized in that the drop-down menu contains a list of possible delivery modalities for the mailpieces that are to be franked.

7. The user interface according to claim 6, characterized in that the selectable postal classes are displayed in a window (80, 90).

8. The user interface according to claim 7, characterized in that, once a postal class has been selected, optional additional services are displayed in another window.

9. The user interface according to one or more of claims 2 to 8, characterized in that the graphical representation of the design of the imprint of the postage indicium to be generated, which, at least in certain areas, is configured as a command panel for opening a screen menu (15, 75), is embedded in a screen display of a text document.

10. The user interface according to one or more of claims 2 to 9, characterized in that the graphical representation of the design of the imprint of the postage indicium to be generated which, at least in certain areas, is configured as a command panel for opening a screen menu (15, 75), is embedded in a screen display of an address.
